(19) United States
(12) Patent Application Publication
(10) Pub. No.: US 2025/0265529 A1
(43) Pub. Date: Aug. 21, 2025

(54) ENABLING NATURAL LANGUAGE INTERACTIONS IN PROCESS VISIBILITY APPLICATIONS USING GENERATIVE ARTIFICIAL INTELLIGENCE (AI)

(71) Applicant: SAP SE, Walldorf (DE)

(72) Inventors: Abhishek KUMAR, Bengaluru / Karnataka (IN); Shantam KHARE, Bhopal / Madhya Pradesh (IN)

(21) Appl. No.: 18/583,089

(22) Filed: Feb. 21, 2024

(51) Int. Cl. G06Q 10/0639

(52) U.S. Cl. CPC G06Q 10/06393

(57) ABSTRACT

A framework that leverages generative artificial intelligence (AI), and in particular large language models (LLMs), to enable the users of a process visibility application to interact with the application's visibility dashboards using natural (human) language requests is provided. In one set of embodiments, this is achieved by converting the natural language requests into prompts for one or more LLMs, where each prompt is contextualized with the visibility scenario of the business process to which the corresponding request pertains, as well as other relevant information.

### BACKGROUND

A process visibility application is a software application that provides users end-to-end operational visibility into an organization's business processes. For example, as instances of a business process are run, a process visibility application can compute visibility data pertaining to the progress of those process instances and can use the visibility data to generate insights into the business process (such as, e.g., key performance indicators (KPIs)) in accordance with a preconfigured visibility scenario. The process visibility application can then present the insights in a graphical user interface, known as a visibility dashboard, to users.

### BRIEF DESCRIPTION OF THE DRAWINGS

FIG. 1 depicts an example process visibility application according to certain embodiments.

FIG. 2 depicts a process visibility application that implements the techniques of the present disclosure according to certain embodiments.

FIG. 3 depicts a natural language request handling workflow according to certain embodiments.

FIG. 4 depicts a natural language-based dynamic process KPI creation workflow according to certain embodiments.

FIG. 5 depicts a natural language-based insight summarization workflow according to certain embodiments.

FIG. 6 depicts an example computer system according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

Embodiments of the present disclosure are directed to a framework that leverages generative artificial intelligence (AI), and in particular large language models (LLMs), to enable the users of a process visibility application to interact with the application's visibility dashboards using natural (human) language requests. For example, in one set of embodiments this framework allows a user to dynamically create a new process KPI in a visibility dashboard via a natural language request. In another set of embodiments, the framework allows a user to obtain a natural language summary of a process insight presented in a visibility dashboard via a natural language request.

As explained in the following sections, the foregoing is generally achieved by converting the natural language requests into prompts for one or more LLMs, which in turn produce outputs that are responsive to, or otherwise enable the fulfillment of, the requests. Significantly, each prompt is contextualized with the visibility scenario of the business process to which the corresponding request pertains, as well as with other relevant information such as business process domain knowledge, similar natural language requests previously submitted by users, visibility data computed for instances of the business process, information regarding the data query protocol employed by the process visibility application, and so on. Through this contextualization, the framework of the present disclosure can advantageously ensure that the created prompts result in correct and consistent LLM outputs, and thus correct and consistent fulfillment of the user requests.

### 1. Example Process Visibility Application and Solution Overview

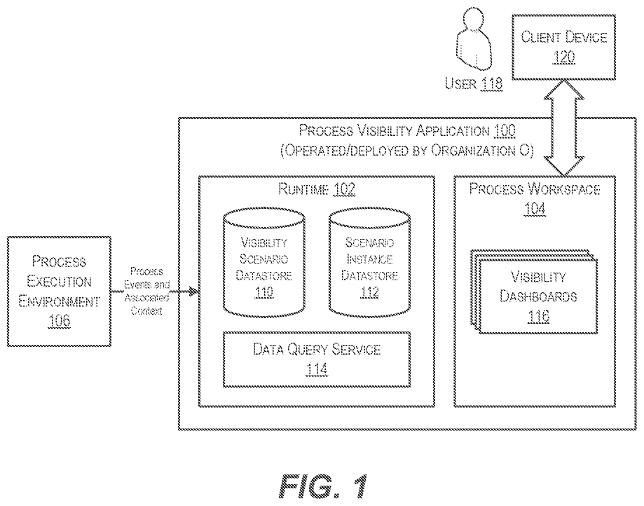

FIG. 1 depicts an example process visibility application 100 in which the framework of the present disclosure may be implemented. As shown, process visibility application 100 is deployed/operated by a hypothetical organization O and comprises a runtime 102 and a process workspace 104. These and other components of process visibility application 100 may run on any type of computer system or set of computer systems known in the art, such as one or more servers in a public or private cloud.

In operation, runtime 102 of process visibility application 100 receives, from a process execution environment 106, process events and associated process context 108 that pertain to instances of business processes of organization O executing within environment 106. For example, in one set of embodiments runtime 102 may receive process events and associated process context pertaining to instances of an accounts payable (i.e., invoice processing) process of organization O. In this scenario, the process events may include, e.g., “create invoice” events, “pay invoice” events, “book invoice” events, and other types of invoice processing events that are typically executed or emitted by an accounts payable workflow. In addition, the associated process context may comprise information relevant to those invoice processing events such as invoice numbers, vendor names, invoice values, and so on.

In response to receiving process events and associated process context 108, runtime 102 analyzes this information to identify the business processes to which they pertain and, for each such business process, correlates the process events and context with a visibility scenario that has been preconfigured for that business process and stored in a visibility scenario datastore 110. This visibility scenario can be understood as a meta-model that comprises, among other things, (1) a model of the business process, including its process event types and process context attributes associated with those types, and (2) visibility semantics that are relevant to the business process, including visibility attributes, visibility expression attributes, and process KPIs that are defined in terms of the process event types, process context attributes, visibility attributes, and/or visibility expression attributes. For instance, an example visibility scenario for an accounts payable process can comprise the various invoice processing events and associated context noted above, as well as visibility attributes such as state (e.g., open, completed, etc.), status (e.g., on track, critical, at risk, etc.), start time, end time, cycle time, etc., visibility expression attributes such as “time of [event],” “duration between [event 1] and [event 2],” etc., and a process KPI that tracks the number of instances of the accounts payable process where the duration between the “create invoice” event and the “pay invoice” event exceeds 90 days. Generally speaking, the visibility scenario for each business process (including its process KPIs) will be manually defined by a process visibility expert that understands the various process visibility semantics (e.g., terminology, attributes, expressions, etc.) that apply to the business process.

The outcome of the correlation step above is a set of one or more scenario instances for each business process, which runtime 102 stores in a scenario instance datastore 112 and makes available to process workspace 104 (along with the visibility scenarios in visibility scenario datastore 110) via a data query service 114. Each scenario instance, which maps to a particular instance of a business process, comprises populated data (referred to as visibility data) for the various visibility attributes defined in that business process's visibility scenario, as derived/computed from the received process events and associated process context. For example, a scenario instance for a particular instance of the accounts payable process can include a populated value of “open” for the state attribute, a populated value of “on track” for the status attribute, and so on based on the process events received for that process instance.

Finally, process workspace 104 retrieves the visibility scenarios and corresponding scenario instances (or portions thereof) stored in datastores 110 and 112 via data query service 114 and uses this data to generate one or more visibility dashboards 116 for presentation to an application user 118 in organization O operating a client device 120. Each visibility dashboard 116 displays, typically in a graphical format, metrics and/or information pertaining to the progress, performance, health, and/or efficiency of a business process (referred to as insights), as defined in the business process's visibility scenario and as reflected in the visibility data for that process's various instances. For example, these displayed insights will include any process KPIs defined in the visibility scenario.

While the foregoing paradigm for process visibility application 100 is functional, it also suffers from a number of limitations. First, because it requires the process KPIs for a business process to be preconfigured (i.e., manually/statically defined) in the process's visibility scenario by a process visibility expert, it is not possible for an ordinary application user (who may be an expert in the business process itself but have no knowledge of process visibility semantics) to dynamically create new process KPIs at the time of reviewing the process's visibility dashboard. This restricts the ability of such users to make most effective use of the application, because they are often interested in slicing and dicing the information displayed in a particular KPI and/or drilling down into specific areas in order to gain additional insights into the business process that are not specifically preconfigured in its visibility scenario.

Second, because the insights in each visibility dashboard are typically presented in a graphical format (via charts or the like), it can sometimes be difficult for application users to intuitively understand the most salient aspects of the insights. This is exacerbated by the fact that the insights may make use of certain process visibility terms (e.g., cycle time, instance, etc.) that are unfamiliar to the users.

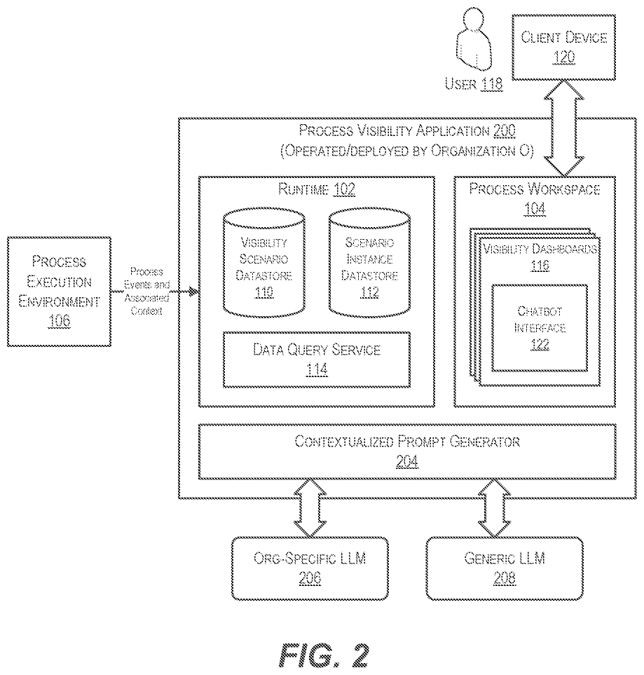

To address the foregoing and other related issues, FIG. 2 depicts an enhanced version 200 of process visibility application 100 in accordance with certain embodiments of the present disclosure. As shown, process visibility application 200 implements a novel natural language interaction framework comprising a chatbot interface 202 in each visibility dashboard 116 and a contextualized prompt generator 204 that is communicatively coupled with at least two large language models (LLMs): an organization-specific LLM 206 and a generic LLM 208. As known in the art, an LLM is a type of generative AI model that is trained on large textual datasets and can interpret and generate natural (human) language text. Organization-specific LLM 206 is trained on one or more datasets proprietary to organization O that include business process domain knowledge collected, curated, and/or generated by O, and generic LLM 208 is trained on publicly available datasets such as data scraped from the Internet.

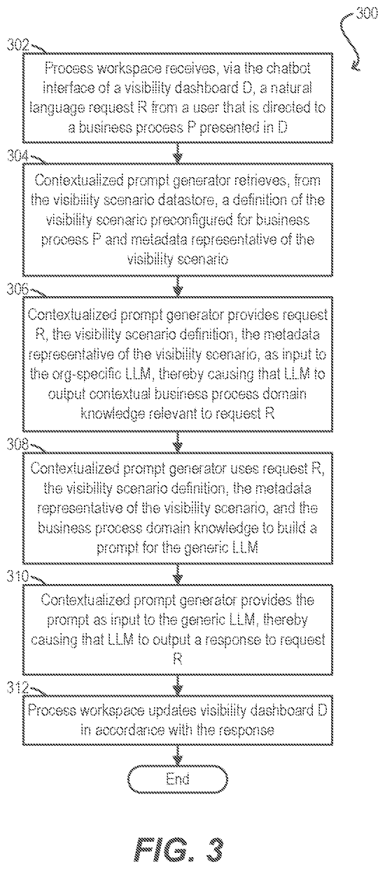

Generally speaking, the new framework shown in FIG. 2 enables the users of process visibility application 200 to interact with the application via natural language for various purposes, including dynamically creating new process KPIs and requesting natural language summaries/explanations of displayed insights. For example, FIG. 3 depicts a high-level workflow 300 that may be executed by process visibility application 200 for handling a natural language request from user 118 using these new components according to certain embodiments.

Starting with step 302, process workspace 104 of process visibility application 200 can receive, via the chatbot interface 202 of a particular visibility dashboard 116 (referred to as visibility dashboard D), a natural language request R from user 118 that is directed to a business process P presented in D. As noted above, request R may be a request to dynamically create a new KPI for business process P in visibility dashboard D, a request to obtain a natural language summary/explanation of an existing insight (e.g., process KPI) displayed in D, or a request to perform any other type of action with respect to P or D (e.g., search for displayed insights related to a particular term or concept, etc.).

In response, process workspace 104 can pass request R to contextualized prompt generator 204, which can retrieve, from visibility scenario datastore 110, a definition of the visibility scenario preconfigured for business process P and metadata representative of that visibility scenario (step 304). For instance, the definition of the visibility scenario may take the form of a JavaScript Object Notation (JSON) file and the metadata representative of the visibility scenario may take the form of a metadata file that is compatible with (or in other words, interpretable by) data query service 114 of runtime 102 (e.g., an Entity Data Model XML (EDMX) file in the case where data query service 114 is an OData service).

In certain embodiments, contextualized prompt generator 204 may retrieve the visibility scenario definition and metadata by calling an application programming interface (API) exposed by data query service 114. In other embodiments, contextualized prompt generator 204 may retrieve this information via a separate communication channel between generator 204 and runtime 102.

At step 306, contextualized prompt generator 204 can provide request R, the visibility scenario definition, and the metadata representative of the visibility scenario as input to organization-specific LLM 206, thereby causing LLM 206 to output contextual business process domain knowledge that the LLM believes to be relevant to R. For example, if request R pertains to a request to dynamically create a new process KPI that reflects the amount of tax paid on a set of invoices, the contextual business process domain knowledge can include information elaborating on the meaning of “tax” in the context of R and the other LLM inputs, in accordance with organization O's institutional knowledge and learnings as captured in organization-specific LLM 206.

Contextualized prompt generator 204 can then use request R, the visibility scenario definition, the metadata representative of the visibility scenario, and the business process domain knowledge output by organization-specific LLM 206 to build a prompt for generic LLM 208, with the goal of instructing generic LLM 208 to produce an output that is responsive to, or enables fulfillment of, R (step 308). Stated another way, generator 204 can build a prompt that is contextualized with all of these pieces of information, thereby increasing the likelihood that generic LLM 208 will produce an output that is correct and consistent. In certain embodiments, as part of building the prompt, generator 204 can reference one of a set of predefined prompt models (shown via reference numeral 210 in FIG. 2). Each of these prompt models can be tailored to a particular type of natural language request and can include a static portion defined by a human prompt engineer and a dynamic portion that is filled in with request R, the visibility scenario definition, the metadata representative of the visibility scenario, and the business process domain knowledge.

Upon building the prompt, contextualized prompt generator 204 can provide it as input to generic LLM 208, thereby causing generic LLM 208 to output a response to request R (step 310). Finally, at step 312, process workspace 104 (either alone or in cooperation with runtime 102) can update visibility dashboard D in accordance with the response and the workflow can end.

With the framework and high-level approach outlined above, a number of advantages are realized. First, by enabling natural language interactions with visibility process application 200 and its visibility dashboards, this framework dramatically improves the usability of application 200 for end-users (particularly those that are unfamiliar to process visibility semantics) and increases user productivity by enabling various functions such as new process KPI creation, insight summarization, and so on in an intuitive and streamlined manner.

Second, by contextualizing and enriching the prompts for generic LLM 208 with visibility scenario definitions/metadata and other relevant information including, e.g., business process domain knowledge output by organization-specific LLM 206, the framework can achieve a high level of accuracy and consistency in producing responses to the natural language requests.

The remaining sections of this disclosure provides details on particular variants of high-level workflow 300 that may be employed by process visibility application 200/contextualized prompt generator 204 for handling a request to dynamically create a new process KPI and a request to obtain a natural language summary of an existing process KPI. It should be appreciated that FIGS. 1-3 and the foregoing description are illustrative and not intended to limit embodiments of the present disclosure. For example, while FIG. 2 depicts a particular arrangement of components in process visibility application 200 other arrangements are possible (e.g., the functionality attributed to a particular component may be split into multiple components, components may be combined or integrated into other components, and so on).

### 2. Dynamic Process KPI Creation Using Natural Language

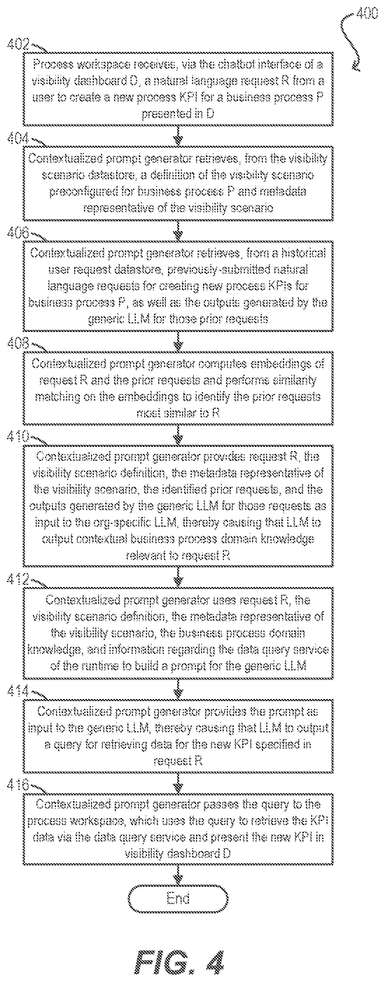

FIG. 4 depicts a natural language-based dynamic process KPI creation workflow 400 according to certain embodiments. Workflow 400 may be executed by process visibility application 200 of FIG. 2 using its natural language interaction framework for enabling users of application 200 to dynamically create new process KPIs in the application's visibility dashboards 116 via natural language requests. As explained in further detail below, this workflow expands upon workflow 300 of FIG. 3 by leveraging additional information, such as prior user requests to create new KPIs and details of data query service 114 of runtime 102, to build and contextualize the prompt that is provided as input to generic LLM 208.

Starting with step 402, process workspace 104 of process visibility application 200 can receive, via the chatbot interface 202 of a particular visibility dashboard 116 (referred to as visibility dashboard D), a natural language request R from user 118 to create a new process KPI for a business process P presented in D. For example, if business process P is an accounts payable process, request R may be “show me total invoice value by business area.”

In response, process workspace 104 can pass request R to contextualized prompt generator 204, which can retrieve, from visibility scenario datastore 110, a definition of the visibility scenario preconfigured for business process P and metadata representative of that visibility scenario (step 404). As mentioned previously, the visibility scenario definition can be formatted according to a first format (e.g., JSON) and the metadata can be formatted according to a second format (e.g., EDMX XML) that is compatible with/interpretable by data query service 114. For instance, the following is an example EDMX XML file comprising the visibility scenario metadata in the case where business process P is an accounts payable process:

<edmx:Edmx
xmlns:edmx=“http://schemas.microsoft.com/ado/2007/06/edmx”
Version=“1.0”>
<edmx:DataServices
xmlns:m=“http://schemas.microsoft.com/ado/2007/08/dataservices/metad
ata” m:DataServiceVersion=“1.0”>
<Schema xmlns=“http://schemas.microsoft.com/ado/2008/09/edm”
Namespace=“com.sap.pvs”>
<EntityType xmlns:sap=“http://www.sap.com/Protocols/SAPData”
Name=“InstanceType” sap:semantics=“aggregate”>
<Key>
<PropertyRef Name=“scenarioInstanceId”/>
</Key>
<Property xmlns:sap=“http://www.sap.com/Protocols/SAPData”
Name=“scenarioInstanceId” Type=“Edm.String” Nullable=“false” sap:pv-
aggregation-role=“dimension” sap:label=“Scenario Instance Id”
sap:visible=“true” sap:filterable=“false” sap:pv-significant-
attribute=“false”/>
<Property xmlns:sap=“http://www.sap.com/Protocols/SAPData”
Name=“companyCode” Type=“Edm.String” Nullable=“true” sap:pv-
aggregation-role=“dimension” sap:label=“Company Code”
sap:visible=“true” sap:pv-significant-attribute=“true” sap:pv-
attribute-type=“context”/>
<Property xmlns:sap=“http://www.sap.com/Protocols/SAPData”
Name=“documentNumber” Type=“Edm.String” Nullable=“true” sap:pv-
aggregation-role=“dimension” sap:label=“Document Number”
sap:visible=“true” sap:pv-significant-attribute=“true” sap:pv-
attribute-type=“context”/>
<Property xmlns:sap=“http://www.sap.com/Protocols/SAPData”
Name=“item” Type=“Edm.String” Nullable=“true” sap:pv-aggregation-
role=“dimension” sap:label=“Item” sap:visible=“true” sap:pv-
significant-attribute=“true” sap:pv-attribute-type=“context”/>
<Property xmlns:sap=“http://www.sap.com/Protocols/SAPData”
Name=“businessArea” Type=“Edm.String” Nullable=“true” sap:pv-
aggregation-role=“dimension” sap:label=“Business Area”
sap:visible=“true” sap:pv-significant-attribute=“true” sap:pv-
attribute-type=“context”/>
<Property xmlns:sap=“http://www.sap.com/Protocols/SAPData”
Name=“documentType” Type=“Edm.String” Nullable=“true” sap:pv-
aggregation-role=“dimension” sap:label=“Document Type”
sap:visible=“true” sap:pv-significant-attribute=“true” sap:pv-
attribute-type=“context”/>
<Property xmlns:sap=“http://www.sap.com/Protocols/SAPData”
Name=“vendor” Type=“Edm.String” Nullable=“true” sap:pv-aggregation-
role=“dimension” sap:label=“Vendor” sap:visible=“true” sap:pv-
significant-attribute=“true” sap:pv-attribute-type=“context”/>
<Property xmlns:sap=“http://www.sap.com/Protocols/SAPData”
Name=“invoiceValue” Type=“Edm.Double” Nullable=“true” sap:pv-
aggregation-role=“measure” sap:label=“Invoice Value”
sap:visible=“true” sap:pv-significant-attribute=“true” sap:pv-
attribute-type=“context” sap:unit=“invoiceValue_Unit”/>
<Property xmlns:sap=“http://www.sap.com/Protocols/SAPData”
Name=“SC_State” Type=“Edm.String” Nullable=“true” sap:pv-
aggregation-role=“dimension” sap:label=“State” sap:visible=“true”
sap:pv-significant-attribute=“true” sap:pv-attribute-
type=“default”/>
<Property xmlns:sap=“http://www.sap.com/Protocols/SAPData”
Name=“SC_Status” Type=“Edm.String” Nullable=“true” sap:pv-
aggregation-role=“dimension” sap:label=“Status” sap:visible=“true”
sap:pv-significant-attribute=“true” sap:pv-attribute-
type=“default”/>
<Property xmlns:sap=“http://www.sap.com/Protocols/SAPData”
Name=“SC_SubStatus” Type=“Edm.String” Nullable=“true” sap:pv-
aggregation-role=“dimension” sap:label=“SubStatus”
sap:visible=“true” sap:pv-significant-attribute=“true” sap:pv-
attribute-type=“default”/>
<Property xmlns:sap=“http://www.sap.com/Protocols/SAPData”
Name=“SC_Number_Of_Instances” Type=“Edm.Int64” Nullable=“true”
sap:pv-aggregation-role=“measure” sap:label=“Number of Invoices”
sap:visible=“true” sap:filterable=“false” sap:pv-significant-
attribute=“false” sap:pv-attribute-type=“default”/>
<Property xmlns:sap=“http://www.sap.com/Protocols/SAPData”
Name=“SC_Start_Time” Type=“Edm.DateTime” Nullable=“true” sap:pv-
aggregation-role=“dimension” sap:label=“Start Time”
sap:visible=“true” sap:pv-significant-attribute=“true” sap:pv-
attribute-type=“default” sap:display-format=“Date”/>
<Property xmlns:sap=“http://www.sap.com/Protocols/SAPData”
Name=“SC_End_Time” Type=“Edm.DateTime” Nullable=“true” sap:pv-
aggregation-role=“dimension” sap:label=“End Time” sap:visible=“true”
sap:pv-significant-attribute=“true” sap:pv-attribute-type=“default”
sap:display-format=“Date”/>
<Property xmlns:sap=“http://www.sap.com/Protocols/SAPData”
Name=“SC_Elapsed_Time” Type=“Edm.Decimal” Nullable=“true” sap:pv-
aggregation-role=“measure” sap:label=“Cycle Time” sap:visible=“true”
sap:pv-significant-attribute=“true” sap:pv-attribute-type=“default”
sap:unit=“SC_Elapsed_Time_Unit” Scale=“2” Precision=“13”/>
<Property xmlns:sap=“http://www.sap.com/Protocols/SAPData”
Name=“SC_Target_Time” Type=“Edm.DateTime” Nullable=“true” sap:pv-
aggregation-role=“dimension” sap:label=“Target Time”
sap:visible=“true” sap:pv-significant-attribute=“true” sap:pv-
attribute-type=“default” sap:display-format=“Date”/>
<Property xmlns:sap=“http://www.sap.com/Protocols/SAPData”
Name=“SC_Threshold_Time” Type=“Edm.DateTime” Nullable=“true” sap:pv-
aggregation-role=“dimension” sap:label=“Threshold Time”
sap:visible=“true” sap:pv-significant-attribute=“true” sap:pv-
attribute-type=“default” sap:display-format=“Date”/>
<Property xmlns:sap=“http://www.sap.com/Protocols/SAPData”
Name=“SC_Active_Phases” Type=“Edm.String” Nullable=“true” sap:pv-
aggregation-role=“dimension” sap:label=“Active Phases”
sap:visible=“true” sap:pv-significant-attribute=“true” sap:pv-
attribute-type=“default”/>
<Property xmlns:sap=“http://www.sap.com/Protocols/SAPData”
Name=“SC_Completed_Phases” Type=“Edm.String” Nullable=“true” sap:pv-
aggregation-role=“dimension” sap:label=“Completed Phases”
sap:visible=“true” sap:pv-significant-attribute=“true” sap:pv-
attribute-type=“default”/>
<Property xmlns:sap=“http://www.sap.com/Protocols/SAPData”
Name=“SC_Active_Steps” Type=“Edm.String” Nullable=“true” sap:pv-
aggregation-role=“dimension” sap:label=“Active Steps”
sap:visible=“true” sap:pv-significant-attribute=“true” sap:pv-
attribute-type=“default”/>
<Property xmlns:sap=“http://www.sap.com/Protocols/SAPData”
Name=“SC_Completed_Steps” Type=“Edm.String” Nullable=“true” sap:pv-
aggregation-role=“dimension” sap:label=“Completed Steps”
sap:visible=“true” sap:pv-significant-attribute=“true” sap:pv-
attribute-type=“default”/>
<Property xmlns:sap=“http://www.sap.com/Protocols/SAPData”
Name=“Invoiced_Manually” Type=“Edm.Int64” Nullable=“true” sap:pv-
aggregation-role=“measure” sap:label=“Invoiced Manually”
sap:visible=“true” sap:pv-significant-attribute=“false” sap:pv-
attribute-type=“calculated”/>
<Property xmlns:sap=“http://www.sap.com/Protocols/SAPData”
Name=“Critical_Vendor” Type=“Edm.Int64” Nullable=“true” sap:pv-
aggregation-role=“measure” sap:label=“Critical Vendor”
sap:visible=“true” sap:pv-significant-attribute=“false” sap:pv-
attribute-type=“calculated”/>
<Property xmlns:sap=“http://www.sap.com/Protocols/SAPData”
Name=“Late_Payment” Type=“Edm.Int64” Nullable=“true” sap:pv-
aggregation-role=“measure” sap:label=“Late Payment”
sap:visible=“true” sap:pv-significant-attribute=“false” sap:pv-
attribute-type=“calculated”/>
<Property xmlns:sap=“http://www.sap.com/Protocols/SAPData”
Name=“Early_Payment” Type=“Edm.Int64” Nullable=“true” sap:pv-
aggregation-role=“measure” sap:label=“Early Payment”
sap:visible=“true” sap:pv-significant-attribute=“false” sap:pv-
attribute-type=“calculated”/>
<Property xmlns:sap=“http://www.sap.com/Protocols/SAPData”
Name=“Percentage_Invoiced_Manually” Type=“Edm.Double”
Nullable=“true” sap:pv-aggregation-role=“measure” sap:label=“%
Invoiced Manually” sap:visible=“true” sap:pv-significant-
attribute=“false” sap:pv-attribute-type=“calculated”
sap:unit=“Percentage_Invoiced_Manually_Unit”/>
<Property xmlns:sap=“http://www.sap.com/Protocols/SAPData”
Name=“End_Day” Type=“Edm.DateTime” Nullable=“true” sap:pv-
aggregation-role=“dimension” sap:label=“End Day” sap:visible=“true”
sap:pv-significant-attribute=“false” sap:pv-attribute-
type=“calculated” sap:display-format=“Date”
sap:semantics=“yearmonthday”/>
<Property xmlns:sap=“http://www.sap.com/Protocols/SAPData”
Name=“End_Week” Type=“Edm.DateTime” Nullable=“true” sap:pv-
aggregation-role=“dimension” sap:label=“End Week” sap:visible=“true”
sap:pv-significant-attribute=“false” sap:pv-attribute-
type=“calculated” sap:display-format=“Date”
sap:semantics=“yearweek”/>
<Property xmlns:sap=“http://www.sap.com/Protocols/SAPData”
Name=“End_Month” Type=“Edm.DateTime” Nullable=“true” sap:pv-
aggregation-role=“dimension” sap:label=“End Month”
sap:visible=“true” sap:pv-significant-attribute=“false” sap:pv-
attribute-type=“calculated” sap:display-format=“Date”
sap:semantics=“yearmonth”/>
<Property xmlns:sap=“http://www.sap.com/Protocols/SAPData”
Name=“Start_Day” Type=“Edm.DateTime” Nullable=“true” sap:pv-
aggregation-role=“dimension” sap:label=“Start Day”
sap:visible=“true” sap:pv-significant-attribute=“false” sap:pv-
attribute-type=“calculated” sap:display-format=“Date”
sap:semantics=“yearmonthday”/>
<Property xmlns:sap=“http://www.sap.com/Protocols/SAPData”
Name=“Start_Week” Type=“Edm.DateTime” Nullable=“true” sap:pv-
aggregation-role=“dimension” sap:label=“Start Week”
sap:visible=“true” sap:pv-significant-attribute=“false” sap:pv-
attribute-type=“calculated” sap:display-format=“Date”
sap:semantics=“yearweek”/>
<Property xmlns:sap=“http://www.sap.com/Protocols/SAPData”
Name=“Start_Month” Type=“Edm.DateTime” Nullable=“true” sap:pv-
aggregation-role=“dimension” sap:label=“Start Month”
sap:visible=“true” sap:pv-significant-attribute=“false” sap:pv-
attribute-type=“calculated” sap:display-format=“Date”
sap:semantics=“yearmonth”/>
<Property xmlns:sap=“http://www.sap.com/Protocols/SAPData”
Name=“Compliance_Issues” Type=“Edm.Int64” Nullable=“true” sap:pv-
aggregation-role=“measure” sap:label=“Compliance Issues”
sap:visible=“true” sap:pv-significant-attribute=“false” sap:pv-
attribute-type=“calculated”/>
<Property xmlns:sap=“http://www.sap.com/Protocols/SAPData”
Name=“invoiceValue_Unit” Type=“Edm.String” Nullable=“true”
sap:semantics=“unit-of-measure” sap:visible=“true”
sap:filterable=“false” sap:pv-significant-attribute=“false”/>
<Property xmlns:sap=“http://www.sap.com/Protocols/SAPData”
Name=“SC_Elapsed_Time_Unit” Type=“Edm.String” Nullable=“true”
sap:semantics=“unit-of-measure” sap:visible=“true”
sap:filterable=“false” sap:pv-significant-attribute=“false”/>
<Property xmlns:sap=“http://www.sap.com/Protocols/SAPData”
Name=“Percentage_Invoiced_Manually_Unit” Type=“Edm.String”
Nullable=“true” sap:semantics=“unit-of-measure” sap:visible=“true”
sap:filterable=“false” sap:pv-significant-attribute=“false”/>
<Property xmlns:sap=“http://www.sap.com/Protocols/SAPData”
Name=“SC_Criticality” Type=“Edm.Byte” Nullable=“true”
sap:label=“SC_Criticality” sap:visible=“true”
sap:filterable=“false”/>
</EntityType>
<EntityContainer Name=“Container” m:IsDefaultEntityContainer=“true”>
<EntitySet xmlns:sap=“http://www.sap.com/Protocols/SAPData”
Name=“Instances” EntityType=“com.sap.pvs.InstanceType”
sap:label=“Instances”/>
</EntityContainer>
</Schema>
</edmx:DataServices>
</edmx:Edmx>

### Listing 1

At step 406, contextualized prompt generator 204 can retrieve, from a historical user request datastore, one or more natural language requests that were previously submitted by user 118 (or alternatively, any user of process visibility application 200) for creating a new process KPI for business process P, as well as the outputs that were generated for those prior requests by generic LLM 208. For example, contextualized prompt generator 204 can retrieve all such requests submitted within some recent time window (e.g., the last 30 days).

Contextualized prompt generator 204 can then compute embeddings (i.e., numerical vectors) of request R received at step 402 and the prior requests retrieved at step 406 and perform similarity matching on the computed embeddings in order to identify the prior requests that are most similar to R (step 408). In certain embodiments contextualized prompt generator 204 can perform this embedding computation by providing each request, along with a command to convert the request into an embedding, as input to an LLM such as generic LLM 208.

Once contextualized prompt generator 204 has identified the prior natural language requests that are most similar to request R, generator 204 can provide R, the visibility scenario definition, the metadata representative of the visibility scenario, the identified prior requests, and the outputs generated by generic LLM 208 for those prior requests as input to organization-specific LLM 206 (step 410). This will cause organization-specific LLM 206 to output contextual business process domain knowledge that the LLM believes to be relevant to request R.

Contextualized prompt generator 204 can then use request R, the visibility scenario definition, the metadata representative of the visibility scenario, the business process domain knowledge output by organization-specific LLM 206, and information regarding data query service 114 to build a prompt for generic LLM 208, with the goal of instructing generic LLM 208 to produce a query for data query service 114 that will return the data needed by the new process KPI (step 412). For instance, if data query service 114 is an OData service, contextualized prompt generator 204 can build a prompt based on these various pieces of information that is intended to produce an OData query. By incorporating into this prompt specific information regarding data query service 114 (such as, e.g., the protocol version supported by service 114, functions supported by service 114, functions not supported by service 114, etc.) in addition to the other pieces of information, contextualized prompt generator 204 can ensure that the generated query conforms with the requirements of data query service 114.

By way of example, the following is an example prompt that may be constructed at step 412 in the case where request R is “show me total invoice value by business area” and data query service 114 is an OData service. The general structure of this prompt may be derived from a prompt model 210 maintained by contextualized prompt generator 204 that is tailored to natural language requests for creating new process KPIs.

```
{
  “deployment_id”: “gpt-4-32k”,
  “messages”: [
{“role”: “system”, “content”: “Assistant is an intelligent chatbot
designed to help users form OData queries based on the prompt given
and the OData service metadata which is known via context. Give
specific OData queries using the context below and if you're not
sure of an answer, you can say ‘I don't know’. Context: - This is
the OData service metadata: <Pass the Metadata>. - Use OData V2 and
so $apply cannot be used. Using $select, it is possible to do
grouping of measures by dimensions and hence do not use $groupby. -
For state, the possible values are ‘OPEN’ or ‘COMPLETED’ or
‘ABRUPTEND’, so interpret prompts accordingly and translate to
queries. - give a single query to achieve the given requirement. -
do not use count function. - only give the OData query without
wrapping explanation.”
},
{“role”: “user”, “content”: “What is OData query to get total
invoice value by business area?”}
```

### Listing 2

Upon building the prompt, contextualized prompt generator 204 can provide it as input to generic LLM 208, thereby causing generic LLM 208 to output a query for retrieving the data for the new process KPI specified in request R (step 414). For example, the following is an OData query that may be output by generic LLM 208 in response to the prompt of Listing 2:

```
“message”: {
    “role”: “assistant”,
    “content”:
“/Instances?$select=businessArea,invoiceValue”
  }
```

### Listing 3

Finally, contextualized prompt generator 204 can pass the query to process workspace 104, which can use the query to retrieve the KPI data from runtime 102 via data query service 114 and present the new KPI with its data in visibility dashboard D (step 416).

### 3. Insight Summarization Using Natural Language

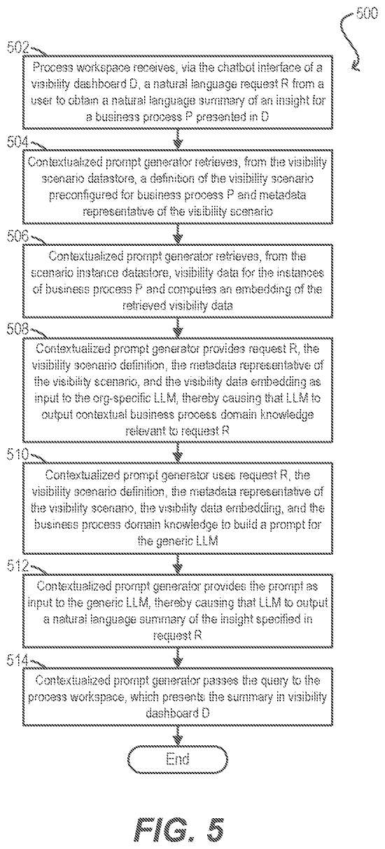

FIG. 5 depicts a natural language-based insight summarization workflow 500 according to certain embodiments. Workflow 500 may be executed by process visibility application 200 of FIG. 2 using its natural language interaction framework for enabling users of application 200 to obtain natural language summaries of insights, such as process KPIs, presented in the application's visibility dashboards 116 via natural language requests. As explained in further detail below, this workflow expands upon workflow 300 of FIG. 3 by leveraging additional information, such as visibility data for the process instances to which the insights pertain, to build and contextualize the prompt that is provided as input to generic LLM 208. Workflow 500 can be applied to both process KPIs that are created dynamically via workflow 400 of FIG. 4 and process KPIs that are statically defined in the visibility scenarios stored in visibility scenario datastore 110.

Starting with step 502, process workspace 104 of process visibility application 200 can receive, via the chatbot interface 202 of a particular visibility dashboard 116 (referred to as visibility dashboard D), a natural language request R from user 118 to summarize an insight for a business process P presented in D (e.g., “explain what the first KPI shown in the dashboard means”). Alternatively, process workspace 104 may receive request R from an automated agent that is configured by user 118 (not shown). For example, user 118 may have configured a setting in process visibility application 200 to generate and send a daily notification email to the user that includes a natural language summary of one or more KPIs of business process P.

In response, process workspace 104 can pass request R to contextualized prompt generator 204, which can retrieve, from visibility scenario datastore 110, a definition of the visibility scenario preconfigured for business process P and metadata representative of that visibility scenario (step 504). Contextualized prompt generator 204 can also retrieve, from scenario instance datastore 112, visibility data for the instances of business process P (step 506) and compute an embedding of the retrieved visibility data (step 506). As with the request embeddings computed in workflow 400, contextualized prompt generator 204 can computing this embedding by providing the visibility data, along with a command to convert the data into an embedding, as input to an LLM such as generic LLM 208.

At step 508, contextualized prompt generator 204 can provide request R, the visibility scenario definition, the metadata representative of the visibility scenario, and the visibility data embedding as input to organization-specific LLM 206. This will cause organization-specific LLM 206 to output contextual business process domain knowledge that the LLM believes to be relevant to request R.

Contextualized prompt generator 204 can then use request R, the visibility scenario definition, the metadata representative of the visibility scenario, the visibility data embedding, and the business process domain knowledge output by organization-specific LLM 206 to build a prompt and provide it to generic LLM 208, thereby causing generic LLM 208 to output a natural language summary of the insight specified in request R (steps 510 and 512).

Finally, contextualized prompt generator 204 can pass the summary to process workspace 104, which can present it to user 118 via the chatbot interface in visibility dashboard D (step 514).

### 4. Example Computer System

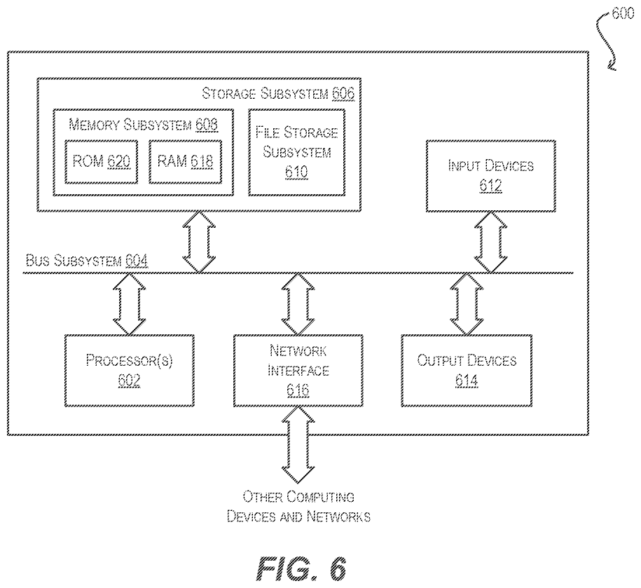

FIG. 6 is a simplified block diagram of an example computer system 600 according to certain embodiments. Computer system 600 (and/or equivalent systems/devices) may be used to run any of the software components described in the foregoing disclosure, including process visibility application of FIG. 2 and its constituent components. As shown in FIG. 6, computer system 600 includes one or more processors 602 that communicate with a number of peripheral devices via a bus subsystem 604. These peripheral devices include a storage subsystem 606 (comprising a memory subsystem 608 and a file storage subsystem 610), user interface input devices 612, user interface output devices 614, and a network interface subsystem 616.

Bus subsystem 604 can provide a mechanism for letting the various components and subsystems of computer system 600 communicate with each other as intended. Although bus subsystem 604 is shown schematically as a single bus, alternative embodiments of the bus subsystem can utilize multiple buses.

Network interface subsystem 616 can serve as an interface for communicating data between computer system 600 and other computer systems or networks. Embodiments of network interface subsystem 616 can include, e.g., an Ethernet module, a Wi-Fi and/or cellular connectivity module, and/or the like.

User interface input devices 612 can include a keyboard, pointing devices (e.g., mouse, trackball, touchpad, etc.), a touch-screen incorporated into a display, audio input devices (e.g., voice recognition systems, microphones, etc.), motion-based controllers, and other types of input devices. In general, use of the term “input device” is intended to include all possible types of devices and mechanisms for inputting information into computer system 600.

User interface output devices 614 can include a display subsystem and non-visual output devices such as audio output devices, etc. The display subsystem can be, e.g., a transparent or non-transparent display screen such as a liquid crystal display (LCD) or organic light-emitting diode (OLED) display that is capable of presenting 2D and/or 3D imagery. In general, use of the term “output device” is intended to include all possible types of devices and mechanisms for outputting information from computer system 600.

Storage subsystem 606 includes a memory subsystem 608 and a file/disk storage subsystem 610. Subsystems 608 and 610 represent non-transitory computer-readable storage media that can store program code and/or data which provide the functionality of embodiments of the present disclosure in a non-transitory state.

Memory subsystem 608 includes a number of memories including a main random access memory (RAM) 618 for storage of instructions and data during program execution and a read-only memory (ROM) 620 in which fixed instructions are stored. File storage subsystem 610 can provide persistent (i.e., non-volatile) storage for program and data files, and can include a magnetic or solid-state hard disk drive, an optical drive along with associated removable media (e.g., CD-ROM, DVD, Blu-Ray, etc.), a removable or non-removable flash memory-based drive, and/or other types of non-volatile storage media known in the art.

It should be appreciated that computer system 600 is illustrative and other configurations having more or fewer components than computer system 600 are possible.

The above description illustrates various embodiments of the present disclosure along with examples of how aspects of these embodiments may be implemented. The above examples and embodiments should not be deemed to be the only embodiments and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments may have been described using a particular combination of hardware and software, it should be recognized that other combinations of hardware and software are possible, and that specific operations described as being implemented in hardware can also be implemented in software and vice versa.

The specification and drawings are, accordingly, to be regarded in an illustrative rather than restrictive sense. Other arrangements, embodiments, implementations, and equivalents will be evident to those skilled in the art and may be employed without departing from the spirit and scope of the present disclosure as set forth in the following claims.

What is claimed is:

1. A method performed by one or more computer systems implementing a process visibility application, the method comprising:
receiving a natural language request directed to a visibility dashboard generated by the process visibility application, the visibility dashboard being a graphical user interface (UI) that presents insights pertaining to one or more instances of a business process, the insights including one or more process key performance indicators (KPIs);
retrieving a definition of a visibility scenario configured for the business process, the visibility scenario comprising a model of the business process, a plurality of visibility-related attributes, and specifications of the one or more process KPIs;
retrieving metadata representative of the visibility scenario, the metadata being formatted in a format interpretable by a data query service of the process visibility application;
providing the natural language request, the definition of the visibility scenario, and the metadata representative of the visibility scenario as input to a first large language model (LLM), thereby causing the first LLM to output business process domain knowledge relevant to the natural language request;
using the natural language request, the definition of the visibility scenario, the metadata representative of the visibility scenario, and the business process domain knowledge to build a prompt for a second LLM;
providing the prompt as input to the second LLM, thereby causing the second LLM to output a response to the natural language request; and
updating the visibility dashboard in accordance with the response.

2. The method of claim 1 wherein the natural language request is a request to create a new process KPI in the visibility dashboard.

3. The method of claim 2 wherein the response is a query to be executed by the data query service.

4. The method of claim 3 wherein updating the visibility dashboard in accordance with the response comprises:
providing the query as input to the data query service, thereby causing the data query service to output data for the new process KPI; and
presenting the new process KPI in the visibility dashboard using the data.

5. The method of claim 2 further comprising:
retrieving one or more previous requests to create new process KPIs previously submitted by the user with respect to the visibility dashboard;
computing embeddings of the request to create the new process KPI and the one or more previous requests;
determining, based on the embeddings, a subset of the one or more previous requests that are similar to the request to create the new process KPI; and
retrieving queries output by the second LLM in response to the subset of the one or more previous requests.

6. The method of claim 5 wherein the queries and the subset of the one or more previous requests are also provided as inputs to the first LLM.

7. The method of claim 5 wherein the queries and the subset of the one or more previous requests are also used to build the prompt for the second LLM.

8. The method of claim 5 wherein the embeddings are computed using the second LLM.

9. The method of claim 5 further comprising:
using information regarding the data query service as additional input to build the prompt for the second LLM.

10. The method of claim 1 wherein the natural language request is a request to provide a natural language summary of an insight presented in the visibility dashboard.

11. The method of claim 10 further comprising:
retrieving visibility data for the one or more instances of the business process, wherein the visibility data was previously computed by the process visibility application based on the visibility scenario and process event data associated with the one or more instances; and
computing one or more embeddings of the visibility data.

12. The method of claim 11 wherein the one or more embeddings of the visibility data are also provided as inputs to the first LLM.

13. The method of claim 11 wherein the one or more embeddings of the visibility data are also used to build the prompt for the second LLM.

14. The method of claim 1 wherein the prompt for the second LLM is built using a prompt model that comprises a static portion defined by a human prompt engineer and a dynamic portion that incorporates the natural language request, the definition of the visibility scenario, the metadata representative of the visibility scenario, and the business process domain knowledge.

15. The method of claim 1 wherein the first LLM is an organization-specific LLM that has been trained on business data owned by an organization implementing the business process, and wherein the second LLM is a generic LLM that has been trained on publicly available data.

16. The method of claim 1 wherein the data query service is an OData service and wherein the metadata representative of the visibility scenario is formatted in Entity Data Model XML (EDMX).

17. The method of claim 1 wherein the request to provide the natural language summary is received from a user of the visibility dashboard via a chatbot interface.

18. The method of claim 1 wherein the natural language request is received from an automated agent that is configured by a user of the visibility dashboard to submit the natural language request on a periodic basis.

19. A non-transitory computer readable storage medium having stored thereon instructions executable by one or more computer systems implementing a process visibility application, the instructions causing the one or more computer systems to:
receive a natural language request directed to a visibility dashboard generated by the process visibility application, the visibility dashboard being a graphical user interface (UI) that presents insights pertaining to one or more instances of a business process, the insights including one or more process key performance indicators (KPIs);
retrieve a definition of a visibility scenario configured for the business process, the visibility scenario comprising a model of the business process, a plurality of visibility-related attributes, and specifications of the one or more process KPIs;
retrieve metadata representative of the visibility scenario, the metadata being formatted in a format interpretable by a data query service of the process visibility application;
provide the natural language request, the definition of the visibility scenario, and the metadata representative of the visibility scenario as input to a first large language model (LLM), thereby causing the first LLM to output business process domain knowledge relevant to the natural language request;
use the natural language request, the definition of the visibility scenario, the metadata representative of the visibility scenario, and the business process domain knowledge to build a prompt for a second LLM;
provide the prompt as input to the second LLM, thereby causing the second LLM to output a response to the natural language request; and
update the visibility dashboard in accordance with the response.

20. A computer system comprising:
one or more processors; and
a computer readable storage medium having stored thereon program code that, when executed by the one or more processors, cause the one or more processors to:
receive a natural language request directed to a visibility dashboard generated by a process visibility application, the visibility dashboard being a graphical user interface (UI) that presents insights pertaining to one or more instances of a business process;
retrieve a definition of a visibility scenario configured for the business process, the visibility scenario comprising a model of the business process and a plurality of visibility-related attributes;
convert the natural language request into a prompt for a large language model (LLM), wherein the prompt is contextualized with at least a portion of the definition of the visibility scenario;
provide the prompt as input to the LLM, thereby causing the LLM to output a response to the natural language request; and
update the visibility dashboard in accordance with the response.
